(19) United States
(12) Patent Application Publication
(10) Pub. No.: US 2008/0235293 A1
(43) Pub. Date: Sep. 25, 2008

(54) METHOD FOR ENHANCED FILE SYSTEM DIRECTORY RECOVERY

(75) Inventors: Alan L. Levering, Rochester, MN (US); Richard M. Theis, Sauk Rapids, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/688,336

(22) Filed: Mar. 20, 2007

(51) Int. Cl. G06F 17/30

(52) U.S. Cl. 707/202; 707/E17.007

(57) ABSTRACT

A method is provided for directory recovery in a file system. Once a directory object problem is identified, a problem directory associated with the directory object problem is determined. A repaired directory is created to take the place of the problem directory, and the repaired directory is linked into the parent directory of the problem directory such that the repaired directory is hidden from an end user. A logical repair directory is created including the problem directory and the repaired directory. Information from the problem directory is moved to the repair directory while the file system is active. The problem directory is renamed to the repaired directory such that the problem directory is hidden from the user, and the repaired directory is made visible to the end user. The problem directory and the logical repair directory are deleted.

The present invention relates to data processing, or, more specifically, to recovering file systems directories.

Computers have a foundation layer of software called an operating system that stores and organizes files and upon which applications depend for access to computer resources. In an operating system, the overall structure in which objects, such as files, are named, stored, and organized is called a file system. File systems are often organized in a namespace that consists of a collection of pathnames used to access the objects stored in the file system. These pathnames ‘map’ or ‘link’ an object into the namespace. A pathname is a sequence of symbols and names that identifies a file. Every file in the namespace has a name, called a filename, so the simplest type of pathname is just a filename. To access files in directories, a pathname identifies a path to the file starting from a working directory or from a root directory to the file. Various operating systems have different rules for specifying pathnames. In DOS systems, for example, the root directory is named ‘\’, and each subdirectory is separated by an additional backslash. In UNIX, the root directory is named ‘/’, and each subdirectory is followed by a slash. In Macintosh environments, a colon separates directories.

The operating system routinely links and unlinks objects in a file system as the objects are created and deleted. As objects are created, the operating system allocates physical space in the file system for an object and links the created object into the namespace for use by the operating system and various software applications. When an object is deleted, the operating system de-allocates the physical space for the object and unlinks the deleted object from the namespace because it is no longer in use.

Occasionally, objects in the file system unintentionally become unlinked from the namespace due to system crashes, data storage problems, hardware malfunctions, or software errors. These objects remain in the file system, but are no longer represented in the namespace. Objects that remain in the file system, but are no longer represented in the namepace and are not in use are called ‘lost’ objects. Lost objects present a problem for users because they are no longer in the namespace and therefore are inacessible by a user through a pathname. As such, unless found, lost objects may result in data being inaccessible to users despite the fact that the data exists in the file system.

File systems comprised of files (e.g., JPEGs, PDFs, etc.) and directories (e.g., folders) need to be repaired on occasion in order to correct problems resulting from system crashes, disk problems, code bugs, lost objects, etc. Most file system repair tools in the industry require the file system to be quieseced to a “restricted” state for the duration of the repair, which may take hours. While in this “restricted” state, all applications and most of the operating system are not allowed to use the file system.

### SUMMARY

According to exemplary embodiments, a method is provided for directory recovery in a file system. Once a directory object problem is identified, a problem directory associated with the directory object problem is determined. A repaired directory is created to take the place of the problem directory. The repaired directory is linked into the parent directory of the problem directory, such that the repaired directory is hidden from an end user. A logical repair directory is created including the problem directory and the repaired directory. The logical repair directory appears as a normal directory to the end user. Information from the problem directory is moved to the repaired directory while the file system is active. The problem directory is renamed to the repaired directory such that the problem directory is hidden from the user, and the repaired directory is made visible to the end user. The problem directory and the logical repair directory are deleted.

### BRIEF DESCRIPTION OF THE DRAWINGS

Referring to the exemplary drawings wherein like elements are numbered alike in the several Figures:

FIG. 1 illustrates a problem directory in a file system according to an exemplary embodiment.

FIG. 2 illustrates creation of a logical repair-in-progress (RIP) directory according to an exempary embodiment;

FIG. 3 illustrates moving of information from a problem directory to a repaired directory to an exemplary embodiment; and

FIG. 4 illustrates replacement of a problem directory with a repaired directory according to anexemplary embodiment.

### DETAILED DESCRIPTION

According to exemplary embodiments, an improved method for recovering file system directory objects is provided. The method enables the file system directory to be repaired while the file system is still active.

A directory object problem may be identified when a directory is first accessed after an initial program load (IPL), during a sweep of the file system by a repair process, or at both times. Once the directory object problem is identified, there are a number of options for handling the problem. One option is to repair the directory. Another option is to mark the directory as having a problem. Yet another option is to delete the directory. The option that is optimal depends on the problem detected. It would be ideal to repair the directory in most cases. However, if it is not possible to repair the directory, it should at least be marked as having a problem so that it can be easily identified later. In most cases, deleting the directory is a last resort. While the directory can be easily marked or deleted, the challenge is to repair the directory while the file system remains active.

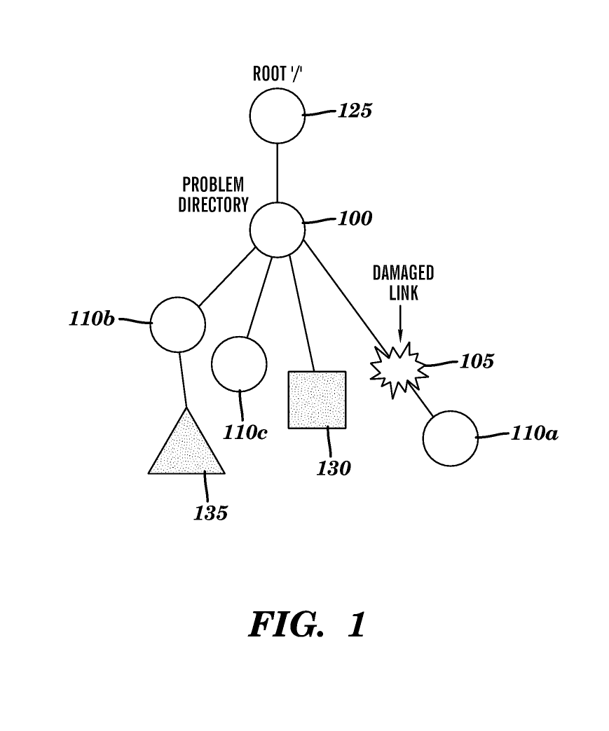

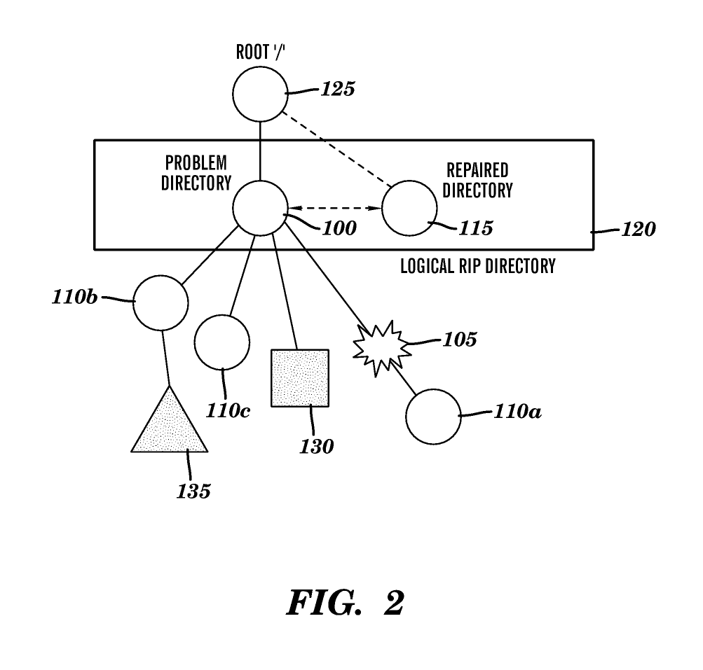

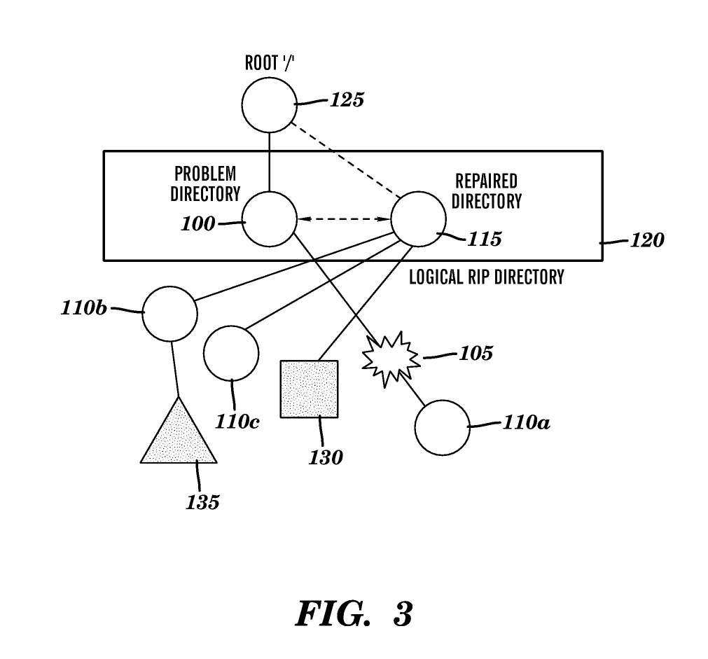

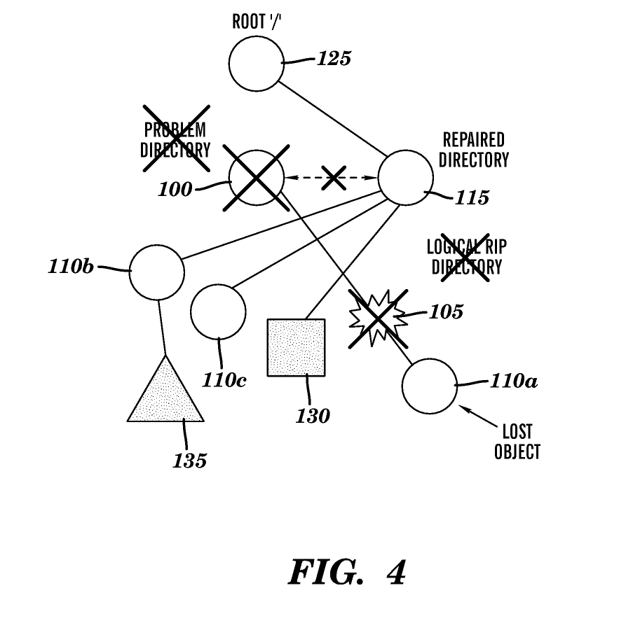

According to an exemplary embodiment, a method is provided for repairing a directory object while a file system is active. According to one embodiment, this is achieved by a method such as that shown in FIGS. 1-4.

Referring to FIG. 1, a problem directory 100 in a file system is found and noted so that the “good” and “bad” information can be more easily identified in later steps. In FIG.1, the problem directory 100 is due to a damage link 105 to an object 110a. There are other directory objects 110b, 110c represented in FIG. 1, but these are not causing a problem for the problem directory 100. The file system also includes a file 130 and a mount 135 to another file system. A logica “repair-in-progress” (RIP) directory 120 is set up on the problem directory. This requires that a number of things occur in an atomic fashion from an end-user's perspective, since the file system is active. First, a new/repaired directory 115 needs to be created to take the place of the problem directory 100. Next, the repaired directory 115 needs to be linked into the same parent (root) directory 125 as the problem directory 100. This is depicted by the dashed line in FIG. 1, from the repaired directory 115 to the root directory 125. However, the link remains hidden from the end user (not shown) for the time being. A new logical RIP directory needs to be created that will temporarily “take the place” of the problem directory. The logical RIP directory 120 includes the problem directory 100 and the repaired directory 115. Basically, the logical RIP directory 120 = the problem directory 100 + the repaired directory 115 when it comes to determining the results for reads, lookup, link counts, and the like. Next, the temporary data structures (e.g., vnodes) need to be updated to indicate this setup.

Once set up, the logical RIP directory 120 is treated as a normal directory, which looks like the original problem directory from an end user's perspective. However, internally, the file system must perform additional actions (e.g., locking, locating links across the directories, etc.) in order to perform various operations (e.g., add/ remove/rename link, read, lookup, determine link count, dot-dot processing, etc.) since there are actually two physical directories that make up the one logical RIP directory. Also, all end user updates to the logical RIP directory 120 are physically made to the required directory 115. This speeds along the repair process and ensures that links are not missed, e.g., newly linked objects.

The problem directory 100 is read through, and as much information as possible (e.g., attributes, links, etc.) is moved into the repaired directory 115. In the end, the repaired directory 115 will contain all of the “good” information found in the problem directory 100. Since the file system remains active during the read, this step should perform appropriate locking and be able to be interrupted in order to avoid perceived slow-downs when accessing the directory from an end-user's perspective. This is important since the problem directory may have millions of links to process.

While reading through the problem directory 100, the locations of the “bad” links and “bad” pages may be saved. This will allow additional repair operations to be performed later.

Once the problem directory has been duplicated, it can be replaced with the repaired directory. This can be accomplished by switching the logical RIP directory 120 with the repaired directory 115, in an manner that does not negatively affect the end user's experience. For this to happen, the problem directory 100 may be renamed as the repaired directory 115, thus making the repaired directory 115 visible and the problem directory 100 not visible to the end user. The problem directory 100 is then deleted and the logical RIP directory 120 is removed. The temporary data structures (e.g., vnodes) are updated to indicate the switch.

It should be noted that the parent directory of the logical RIP directory needs special processing to handle its link counts (hidden vs. visible directory). It also needs special processing to handle the remaining or deletion of the logical RIP directory.

Once the repaired directory 115 is active, a “find lost file system object while active” process may be used to perform additional repairs. In particular, if a lost object, such as object 110a, is found, a determination may be made whether its parent link points to one of the saved “bad” links or pages found earlier. If it does, then the lost object belongs in the repaired directory and it can be relinked appropriately.

Finally, there are times during the repair during which the link attributes (e.g., mode) are completely or practically lost. In such cases, the values may be set for the lost attribute for the object in several ways. For example, the attribute may be set to a default value (e.g., mode=rwxrwxrwx). As another example, other similar objects with the same parent directory may be found, and the attribute may be set to the “common”value found across the objects (e.g., mode=rwx-x-x). If other similar objects with the same parent directory are not found, the parent directory “create object attributes” may be used to define what value should be set in newly created child objects. If applicable, these attributes can be used (e.g., mode=rwxr-xr-x).

Exemplary embodiments of the present invention are described largely in the context of a fully functional computer system for directory recovery in a file system having a namespace. Readers of skill in the art will reconize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately reconize that any computer system having suitable programming means will be capable of executing the steps of the method of the invention as embodied in a program product. Persons skilled in the art will reconize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for directory recovery in a file system, the method comprising:
identifying a directory object problem;
determining a problem directory associated with the directory object problem;
creating a repaired directory to take the place of the problem directory;
linking the repaired directory into the parent directory of the problem directory, wherein the repaired directory is hidden from an end user;
creating a logical repair directory including the problem directory and the repaired directory, wherein the logical repair directory is visible to the end user;
moving information from the problem directory to the repaired directory while the file system is active;
renaming the problem directory to the repaired directory such that the problem directory is hidden from the user, and the repaired directory is made visible to the end user;
deleting the problem directory; and
deleting the logical repair directory.

2. The method of claim 1, wherein while information is being moved from the problem directory to the repaired directory, end-user updates to the logical repair directory are physically made to the repaired directory.

3. The method of claim 1, wherein the information being moved from the problem directory to the repaired directory includes at least attributes and links.

4. The method of claim 1, wherein the directory object problem is a damaged link.
